(19) United States
(12) Patent Application Publication
(10) Pub. No.: US 2012/0013196 A1
(43) Pub. Date: Jan. 19, 2012

(54) Fuel cell system and power managing method of the same

(76) Inventors: Young-jae Kim, Seoul (KR); Lei Hu, Yongin-Si (KR); Jin S. Heo, Hwaseong-si (KR); Hye-jung Cho, Anyang-si (KR)

(21) Appl. No.: 13/137,013

(22) Filed: Jul. 15, 2011

(30) Foreign Application Priority Data
Jul. 16, 2010 (KR) 10-2010-0069165

(51) Int. Cl. H02J 1/00

(52) U.S. Cl. 307/82

(57) ABSTRACT

A fuel cell system, which provides output power of at least one of a fuel cell and a battery to a load, selects any one operating mode from among various operating modes of the fuel cell system based on a change in performance of the battery due to use of the battery, and controls supplying of output power of the fuel cell and output power of the battery to the load according to the selected operating mode.

### CROSS-REFERENCE TO RELATED APPLICATIONS

This application claims the benefit of Korean Patent Application No. 10-2010-0069165, filed on Jul. 16, 2010, in the Korean Intellectual Property Office, the disclosure of which is incorporated herein in its entirety by reference.

BACKGROUND

1. Field

One or more embodiments relate to a fuel cell system and a fuel cell power managing method of the fuel cell system.

2. Description of the Related Art

A fuel cell has been highlighted along with a solar cell as environmentally-friendly alternative energy technology for generating electrical energy from a material, e.g., hydrogen, that is abundant on earth. In general, a fuel cell has a large impedance so as to have a low response speed with respect to a load change. In order to compensate for this, a chargeable secondary cell may be mounted in a fuel cell system which is currently being developed.

### SUMMARY

Provided are a fuel cell system with high fuel and performance efficiencies, which stabilizes the output voltage of the fuel cell system while performing constant-current driving of a fuel cell, and a fuel cell power managing method of the fuel cell system. In addition, provided is a computer readable recording medium having recorded thereon a program for executing the power managing method.

Additional aspects will be set forth in part in the description which follows and, in part, will be apparent from the description, or may be learned by practice of the presented embodiments.

According to an aspect, example embodiments provide a fuel cell system for providing output power of at least one of a fuel cell and a battery to a load, the fuel cell system including a first converter configured to change an output voltage of the fuel cell, a second converter configured to change an output voltage of the first converter and an output voltage of the battery, and a controller configured to control an operation of the first converter and an operation of the second converter according to a change in performance of the battery due to battery usage.

The controller may be configured to control operations of the first and second converters according to a change in a state of charge (SOC) of the battery and/or a change in an output voltage of the battery.

The controller may be configured to control the operation of the first converter so that a constant current is output from the fuel cell.

The controller may be configured to control the operation of the second converter so that power at a voltage equal to or greater than a predetermined value is supplied to the load.

The fuel cell system may further include a switch configured to switch a direct-connection between the battery and the load, the controller controlling an operation of the first converter and an operation of the second converter according a change in the performance of the battery, and controlling on/off operations of the switch.

When current performance of the battery is more than a predetermined level, the controller may be configured to supply the output power of the battery to the load by disabling the first converter and turning on the switch.

When current performance of the battery is less than a predetermined level, the controller may be configured to supply the output power of the fuel cell and the output power of the battery to the load by enabling the first converter and turning off the switch.

When the output voltage of the battery is less than a predetermined value, the controller may be configured to enable the second converter and to control the operation of the second converter, so that a voltage equal to or greater than the predetermined value is output from the second converter.

According to another aspect, example embodiments provide a power managing method of a fuel cell system for providing output power of at least one of a fuel cell and a battery to a load, the power managing method including selecting an operating mode of the fuel cell system based on a change in performance of the battery due to battery usage, and controlling supply of an output power of the fuel cell and an output power of the battery to the load according to the selected operating mode.

The change in the performance of the battery may include at least one of a change in a state of charge (SOC) of the battery and a change in an output voltage of the battery.

When current performance of the battery is more than a predetermined level, the selecting may include selecting a battery mode for supplying only output power of the battery to the load, and the controlling may include turning off the output power of the fuel cell and supplying the output power of the battery to the load in the battery mode.

When the output voltage of the battery is less than a predetermined value, the controlling may include increasing the output voltage of the battery, and supplying power at the increased output voltage.

The power managing method may further include, when current performance of the battery is less than a predetermined level, changing an operating mode from the battery mode to a start-up mode, and supplying a portion of the output power of the battery in the start-up mode, such that the operation of the fuel cell starts.

The power managing method may further include, when an output state of the fuel cell is stable, changing the operating mode from the start-up mode to a normal mode, and simultaneously supplying the output power of the fuel cell and the output power of the battery to the load in the normal mode.

When the output voltage of the battery is less than a predetermined value, the controlling may include increasing the output voltage of the battery, and supplying power at the increased output voltage.

According to another aspect, example embodiments provide a computer readable recording medium having recorded thereon a program for executing a power managing method of a fuel cell system for providing output power of at least one of a fuel cell and a battery to a load, the power managing method including selecting any one operating mode from among various operating modes of the fuel cell system based on a change in performance of the battery due to battery usage; and controlling supplying of output power of the fuel cell and output power of the battery to the load according to the selected operating mode.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph of charge characteristics of a lithium battery;

FIGS. 2 and 3 are graphs of charging characteristics of a lithium battery in a fuel cell system that performs constant-current driving of a fuel cell;

FIG. 4 is a structural diagram of a fuel cell system according to an embodiment;

FIG. 5 is a detailed circuit diagram of a first direct current (DC)/DC converter and a second DC/DC converter of FIG. 4;

FIG. 6 is a flowchart of a power managing method of a fuel cell system according to an embodiment;

FIG. 7 shows waveforms of an output current of a fuel cell and an output current of a battery in the power managing method of FIG. 6 according to an embodiment;

FIG. 8 is a detailed flowchart of a battery mode of an operation of FIG. 6;

FIG. 9 shows a current flow in the battery mode when an output voltage of a battery is equal to or greater than 3.7 V in the circuit diagram of FIG. 5;

FIG. 10 shows a current flow in the battery mode when an output voltage of a battery is less than 3.7 V;

FIG. 11 is a detailed flowchart of the normal mode of an operation of FIG. 6;

FIG. 12 shows a current flow in a normal mode when an output voltage of a battery is equal to or greater than 3.7 V in the circuit diagram of FIG. 5;

FIG. 13 shows a current flow in a battery mode when an output voltage of a battery is less than 3.7 V in the circuit diagram of FIG. 5; and

FIG. 14 shows waveforms of an output current of a fuel cell and an output current of a battery in the power managing methods of FIGS. 8 and 11 according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

One or more embodiments relate to a fuel cell system and a fuel cell power managing method. In order to clearly describe the one or more embodiments, detailed descriptions about stacks, Balance of Plants (BOP), and the like, of a fuel cell, which are well known to one of ordinary skill in the art, are omitted here. In fact, a current and voltage output from the fuel cell indicate the current and voltage output from the stacks of the fuel cell. However, for convenience of description, the current and voltage output from the stacks of the fuel cell are referred to as ‘the current and voltage output from the fuel cell’.

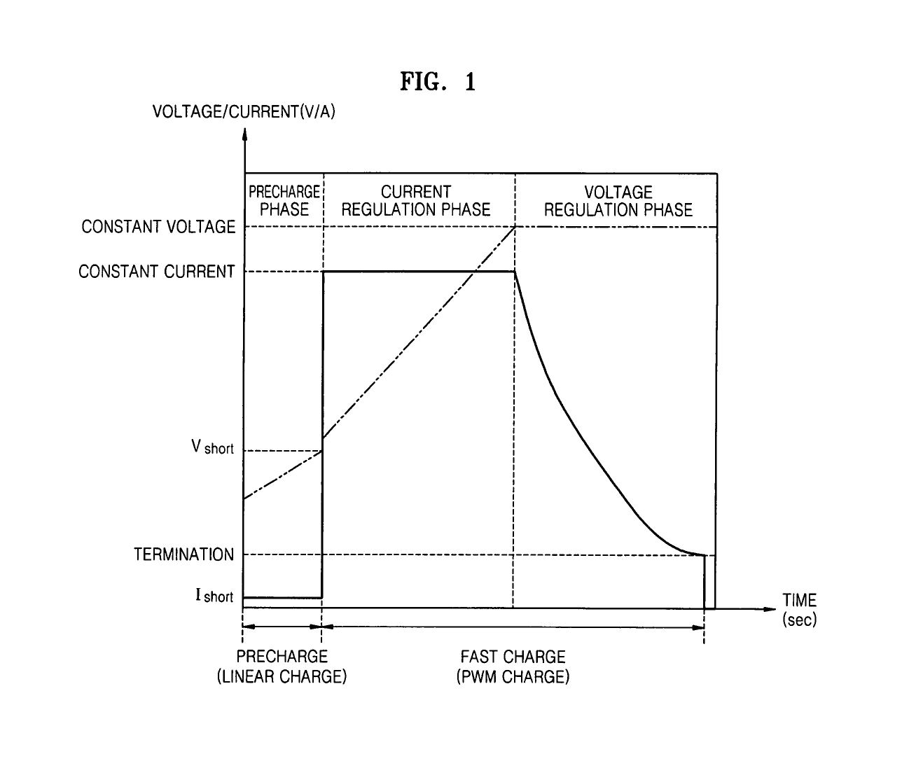

FIG. 1 is a graph of charge characteristics of a lithium battery. In FIG. 1, a solid line is a charging current, and a dotted line is a charging voltage. The lithium battery is a secondary battery using lithium in a cathode, e.g., a lithium ion battery, a lithium polymer battery, or the like. Since the lithium battery has a high energy density, the lithium battery has been widely used as an auxiliary power source for a cell battery, a power source of a cellular phone, or the like.

Referring to FIG. 1, a charging operation of the lithium battery includes a precharge phase, a current regulation phase, and a voltage regulation phase. The precharge phase uses a linear charge method. The current regulation phase and voltage regulation phase use a speed charging method such as a pulse width modulation (PWM) charging method. In general, a charging limit voltage of the lithium battery is 4.2V. When a charging power source voltage applied to the lithium battery exceeds the charging limit voltage, the performance of the lithium battery may deteriorate. Thus, when the lithium battery is charged, the charging limit voltage needs to be considered.

In the precharge phase, a current value and voltage value of the charging power source voltage provided to the lithium battery are set as Iₛₕₒᵣₜ and Vₛₕₒᵣₜ, respectively, so that the lithium battery may adapt to the charging. In this case, a voltage of the lithium battery is gradually increased to Vₛₕₒᵣₜ. In the current regulation phase, while a predetermined current value of the charging power source supplied to the lithium battery is maintained, the voltage value of the charging power source voltage is increased to the charging limit voltage 4.2V. In this case, if the predetermined current value is excessively high, since the lithium battery may deteriorate, a current value limit is set in consideration of the performance of the lithium battery, for example, a discharging rate, or the like. In the voltage regulation phase, when the voltage value of the charging power source applied to the lithium battery is maintained at the charging limit voltage 4.2V, as a charging capacity of the lithium battery is increased, the current value of the charging power source is gradually reduced.

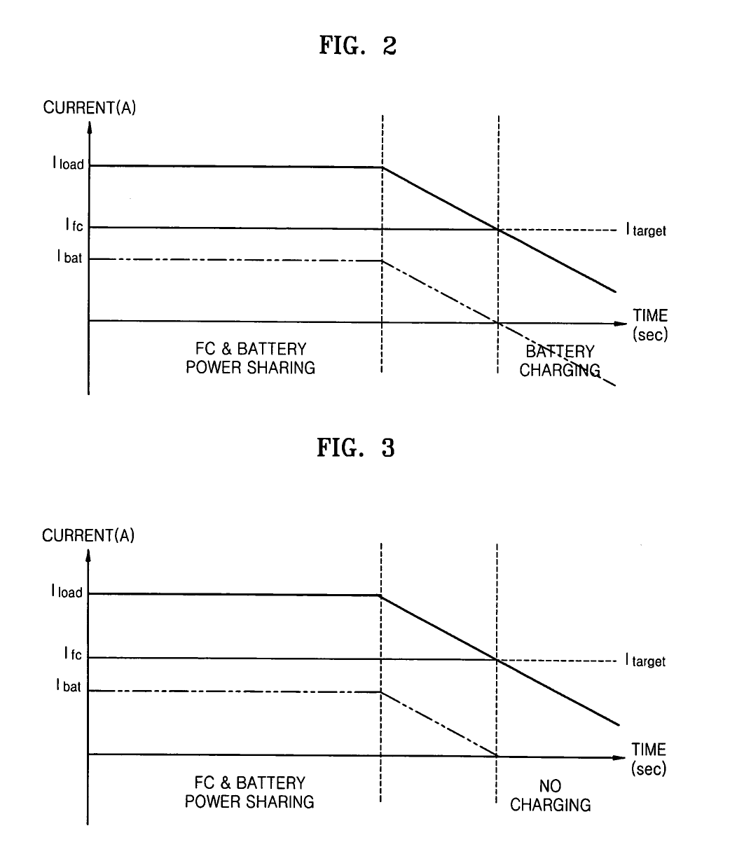

FIGS. 2 and 3 are graphs of charging characteristics of a lithium battery in a fuel cell system that performs constant-current driving on a fuel cell. In general, the fuel cell system performs constant-current driving for outputting a constant current from the fuel cell, or performs constant-voltage driving for outputting a constant voltage from the fuel cell. When the fuel cell system performs the constant-current driving on the fuel cell, a voltage output from the fuel cell is variable. When the fuel cell system performs the constant-voltage drive on the fuel battery, a current output from the fuel cell is variable. In particular, in FIGS. 2 and 3, the fuel cell system functions as a main power source of a load, and the lithium battery starts an operation of the fuel cell, or functions as an auxiliary power source of the load. With reference to FIGS. 2 and 3, problems of the fuel cell system performing the constant-current driving on the fuel cell will now be described.

In general, the end of the current regulation phase of FIG. 1 corresponds to a charging capacity of the lithium battery of about 80% of the maximum charging capacity of the lithium battery. FIG. 2 shows a case where the charging capacity of the lithium battery is less than 80% of the maximum charging capacity of the lithium battery. In this case, since the lithium battery is charged in the current regulation phase of FIG. 1, while the current value of the charging power source provided to the lithium battery is maintained, the voltage value of the charging power source is increased to 4.2 V. Referring to FIG. 2, as power consumption of the load is changed, current supplied to the load is maintained, and then is reduced. If the current supplied to the load is maintained, a constant current is supplied to the load simultaneously from the fuel cell and the lithium battery. When the current supplied to the load is reduced, since the fuel cell system performs the constant-current driving, the constant current I_{target} is supplied from the fuel cell to the load, but a current supplied from the lithium battery to the load is reduced. In particular, when a current supplied to the load is reduced to a current less than the constant I_{target} output from the fuel cell, surplus power of the fuel battery is used to charge the lithium battery.

FIG. 3 shows a case where the charging capacity of the lithium battery is equal to or greater than 80% of the maximum charging capacity of the lithium battery. In this case, since the lithium battery is charged in the voltage regulation phase of FIG. 1, while the voltage value of the charging power source provided to the lithium battery is maintained at 4.2 V, the current value of the charging power source is gradually reduced. Referring to FIG. 3, as power consumption of the load is changed, current supplied to the load is maintained, and then is reduced. If the current supplied to the load is maintained, a constant current is supplied to the load simultaneously from the fuel cell and the lithium battery. When the current supplied to the load is reduced, since the fuel cell system performs the constant-current driving, the constant current I_{target} is supplied from the fuel cell to the load, but a current supplied from the lithium battery to the load is reduced. When the current supplied to the load is reduced to a current less than the constant current I_{target} output from the fuel cell, the lithium battery is not charged. When the charging capacity of the lithium battery is equal to or greater than 80% of the maximum charging capacity of the lithium battery, a charging voltage value needs to be maintained at a high voltage of 4.2 V. However, since the fuel cell system performs the constant-current driving, a predetermined voltage value is not supplied from the fuel cell. If the fuel cell system performs the constant-voltage driving on the fuel cell in order to charge the lithium battery, the fuel cell system may loose the original function of constant-current drive. In addition, the fuel cell may be driven at a high voltage, and thus the durability of the cell battery may deteriorate.

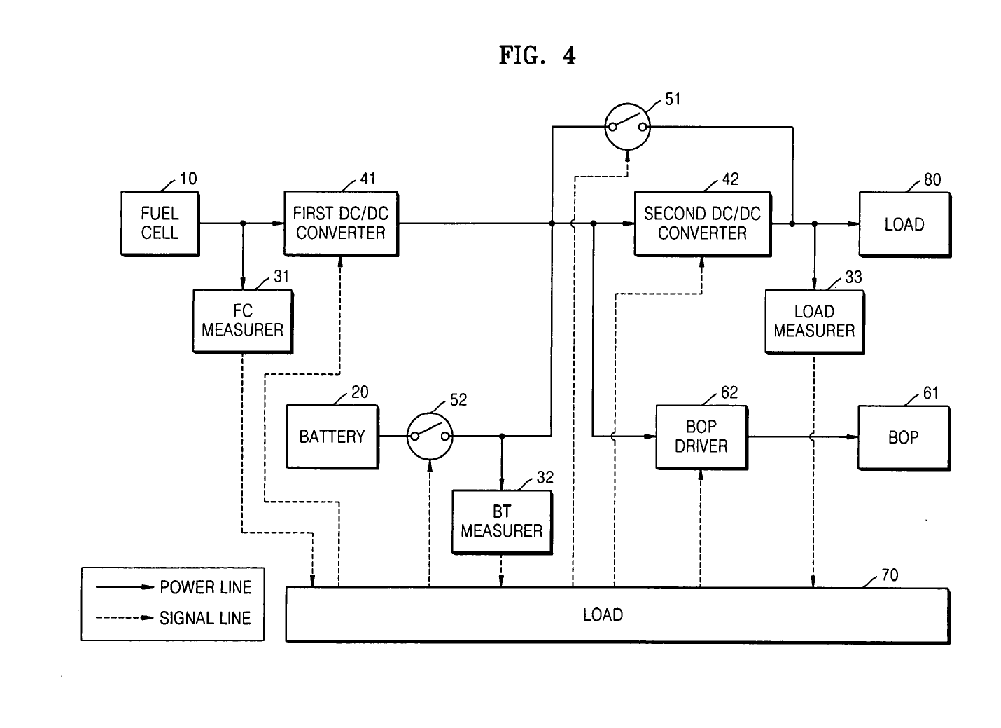

FIG. 4 is a structural diagram of a fuel cell system according to an example embodiment. Referring to FIG. 4, the fuel cell system according to the present embodiment includes a fuel cell 10, a battery 20, a fuel cell (FC) measurer 31, a battery (BT) measurer 32, a load measurer 33, a first direct current (DC)/DC converter 41, a second DC/DC converter 42, a bypass (BP) switch 51, a battery (BT) switch 52, a balance of plant (BOP) 61, a BOP driver 62, and a controller 70. In particular, the fuel cell system has a hybrid structure for supplying power output from at least one of the fuel cell 10 and the battery 20 according to a change in the performance of the battery 20 due to use of the battery 20.

The fuel cell 10 is a generator for converting chemical energy contained in fuel directly into electric energy by an electrochemical reaction so as to produce DC power. The fuel cell 10 may be, e.g., a solid oxide fuel cell (SOFC), a polymer electrolyte membrane fuel cell (PEMFC), a direct methanol fuel cell (DMFC), or the like.

The battery 20 may function as a power source for starting an operation of the fuel cell 10, or may function as a power source for the load 80 together with the fuel cell 10. According to embodiments, the battery 20 may be a lithium battery, or may be a high capacity rechargeable capacitor. Likewise, since the fuel cell system including the battery 20 may independently produce power, the fuel system including the battery 20 may be used as a portable fuel cell system. In general, a small-sized DMFC, as compared to other fuel cells, may be used as a fuel cell of the portable fuel cell system.

The FC measurer 31 measures an output state of the fuel cell 10. For example, the FC measurer 31 measures an output current value and/or an output voltage value of the fuel cell 10. According to the present embodiment, the current value and voltage value of the fuel cell 10 indicates a current value or voltage value between an anode and a cathode of stacks of the fuel cell 10. The BT measurer 32 measures an output state of the battery 20. For example, the BT measurer 32 measures an output current value and output voltage value of the battery 20. The load measurer 33 measures an input state of the load 80. For example, the load measurer 33 measures an input current value and/or an input voltage value of the load 80. In FIG. 4, an operation of the second DC/DC converter 42 is determined with reference to an output voltage of the battery 20. The output voltage of the battery 20 indicates a voltage value measured by the BT measurer 32. In order to finely adjust a voltage required by the load 80, the operation of the second DC/DC converter 42 may be determined with reference to the input voltage of the load 80 measured by the load measurer 33.

The first DC/DC converter 41 changes the output voltage of the fuel cell 10 to a voltage based on control of the controller 70. In particular, the first DC/DC converter 41 changes the output voltage of the fuel cell 10 so that a constant current may be output from the fuel cell 10 according to the control of the controller 70. When power output from the fuel cell 10 is changed due to a change in the state of the fuel cell 10 or the load 80, the output current of the fuel cell 10 may be maintained by changing the output voltage of the fuel cell 10. Thus, since the first DC/DC converter 41 may perform the constant-current drive on the fuel cell 10 even while the load 80 is changed, fuel may be constantly provided to the fuel cell 10, and thus the lifetime of the fuel cell 10 may be increased.

The second DC/DC converter 42 changes at least one of an output voltage of the first DC/DC converter 41 and an output voltage of the battery 20 into a voltage based on control of the controller 70. In particular, when at least one of the output voltage of the first DC/DC converter 41 and the output voltage of the battery 20 does not match a predetermined target voltage, e.g., a voltage required by the load 80, the second DC/DC converter 42 changes at least one of the output voltage of the first DC/DC converter 41 and the output voltage of the battery 20 to the target voltage according to control of the controller 70. Thus, since the second DC/DC converter 42 may maintain a voltage input to the load 80 at a predetermined level or more, the input voltage of the load 80 may be stabilized. In addition, surplus power that remains after output power of the second DC/DC converter 42 is supplied to the load 80 may be used to charge the battery 20. In this case, when the output voltage of the first DC/DC converter 41 does not match a charging voltage of the battery 20, the second DC/DC converter 42 may change the output voltage of the first DC/DC converter 41 to the charging voltage of the battery 20.

The BP switch 51 switches direct-connection between output terminals of the first DC/DC converter 41 and the battery 20 to the load 80, or between the output terminal of the first DC/DC converter 41 and the load 80, according to control of the controller 70. In other words, the BP switch 51 turns on/off the connection between a first power line connected to the battery 20 and first DC/DC converter 41, and a second power line connected to the second DC/DC converter 42 and the load 80. As such, in consideration of a change in the performance of the battery 20, the controller 70 can disconnect the first DC/DC converter 41 and the battery 20 from the load 80, i.e., the output power of the first DC/DC converter 41 and the battery 20 may be bypassed instead of being transmitted to the output of the second DC/DC converter 42.

The BT switch 52 is positioned at an output terminal of the battery 20, thereby turning on or off the output of the battery 20 according to control by the controller 70.

The BOP 61 includes peripheral devices for driving the fuel cell 10, such as a pump for providing fuel, e.g., hydrogen (H₂), to the fuel cell 10, and an oxidizer for oxidizing the fuel. For example, the BOP 61 may include a pump for providing air, oxygen, or the like, and a pump for providing a coolant. In general, the BOP 61 is driven by power provided by the fuel cell 10, i.e., power output from the first DC/DC converter 41. However, when the fuel cell 10 does not supply power sufficiently, or the first DC/DC converter 41 does not operate, the BOP 61 may be driven by power output from the battery 20. The BOP driver 62 drives the BOP 61 according to control by the controller 70. That is, the BOP driver 62 provides fuel, air, coolant, or the like to the fuel cell 10 by driving the above-described pumps according to control of the controller 70. Thus, the fuel cell 10 may produce power.

The controller 70 determines the current performance of the battery 20 by using the output state of the battery 20 measured by the BT measurer 32, i.e., at least one of the output current and output voltage of the battery 20, controls each operation of the first DC/DC converter 41 and the second DC/DC converter 42 according to a change in the performance of the battery 20, and control on/off operations of the BP switch 51. For example, the controller 70 may calculate a state of charge (SOC) of the battery 20 by using at least one of the output current value and output voltage value of the battery 20 measured by the BT measurer 32, and may control each operation of the first DC/DC converter 41 and the second DC/DC converter 42 and on/off on the BP switch 51 according to the SOC of the battery 20, in order to appropriately distribute power of the fuel cell 10 and power of the battery 20 to the load 80 according to a change in the SOC of the battery 20 due to use of the battery 20.

According to another embodiment, which uses the SOC of the battery 20, the controller 70 may control each operation of the first DC/DC converter 41 and the second DC/DC converter 42 according to a change in the output voltage of the battery 20. Alternatively, the controller 70 may control each operation of the first DC/DC converter 41 and the second DC/DC converter 42 in consideration of a change in the SOC of the battery 20 together with a change in the output voltage of the battery 20. It will be understood by one of ordinary skill in the art that other parameters in addition to the SOC of the battery 20 and the output voltage of the battery 20 may be used to indicate the performance of the battery 20.

Examples of a method of measuring the SOC of the battery 20 may include, e.g., a chemical method, a voltage method, a current integration method, a pressure method, and the like. In the fuel cell system of FIG. 4, the voltage method and the current integration method are used. In the voltage method, an output voltage of the battery 20 is measured, and the output voltage is applied to a discharge curve of the battery 20 to calculate the SOC of the battery 20. In the current integration method, the output current of the battery 20 is measured and integrated over an entire usage time period to calculate the SOC of the battery 20.

In more detail, when the current performance of the battery 20 exceeds a predetermined level, e.g., when the SOC of the battery 20 is equal to or greater than 50% of the original performance, the controller 70 disables the first DC/DC converter 41, and turns on the BP switch 51 so as to supply only the output power of the battery to the load 80. In addition, when the current performance of the battery 20 is less than a predetermined level, e.g., when the SOC of the battery 20 is less than 50%, the controller 70 enables the first DC/DC converter 41, and turns on the BP switch 51 so as to supply the output power of the fuel cell 10 together with the output power of the battery 20 to the load 80.

The controller 70 controls an operation of the first DC/DC converter 41 so that the fuel cell 10 may output a constant current. The output power of the first DC/DC converter 41 may be supplied to both the load 80 and the battery 20, or to only the load 80, according to a voltage difference between the output voltage of the first DC/DC converter 41 and the output voltage of the battery 20. The power output from the first DC/DC converter 41 and input to the battery 20 is used to charge the battery 20. In other words, surplus power that remains after output power of the first DC/DC converter 41 is supplied to the load 80 is used to charge the battery 20.

In addition, the controller 70 controls an operation of the second DC/DC converter 42 so that power at a voltage equal to or greater than a predetermined value may be supplied to the load 80. In more detail, when the output voltage of the battery 20 is less than a predetermined value, e.g., when the output voltage of the battery 20 is less than 3.7 V multiplied by a cell number of the battery 20, the controller 70 enables the second DC/DC converter 42, and controls an operation of the second DC/DC converter 42 so that the second DC/DC converter 42 may output a voltage equal to or greater than 3.7 V multiplied by a cell number of the battery 20.

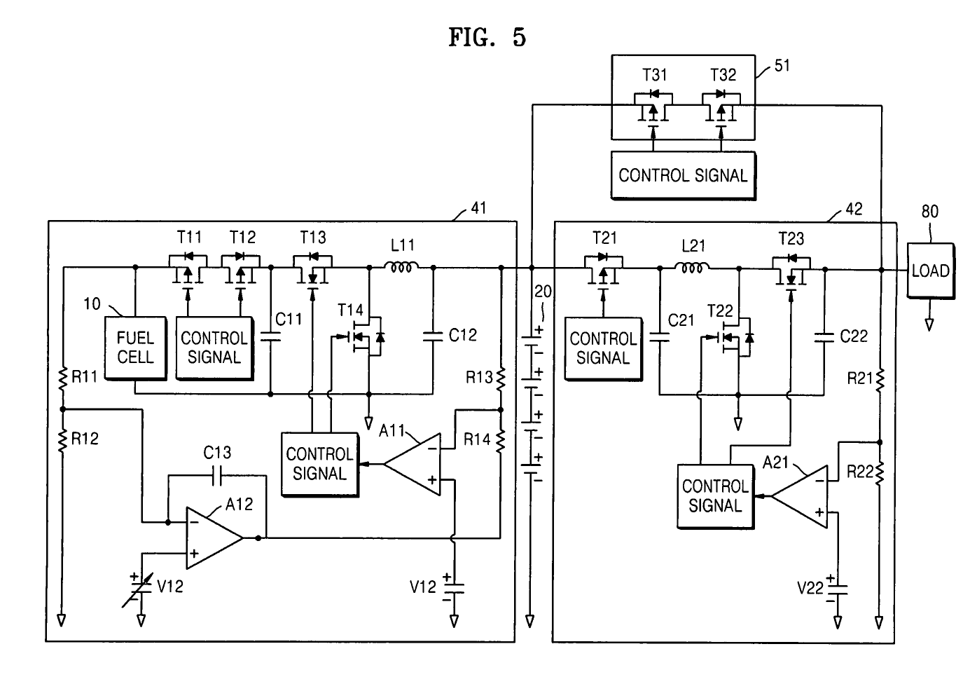

FIG. 5 is a detailed circuit diagram of the first DC/DC converter 41 and the second DC/DC converter 42 of FIG. 4. In order to avoid complexity of the whole circuit diagram and to illustrate circuits for the first DC/DC converter 41 and the second DC/DC converter 42 in more detail, only the fuel cell 10, the battery 20, the BP switch 51, and the load 80 are illustrated in addition to the first DC/DC converter 41 and the second DC/DC converter 42, and other components are omitted. In particular, transistors of the first DC/DC converter 41 and the second DC/DC converter 42 in FIG. 5 may each be a metal oxide semiconductor field effect transistor (MOSFET) whose internal power is barely consumed.

Referring to FIG. 5, the first DC/DC converter 41 is embodied as a buck converter including transistors T13 and T14, a capacitor C11, and an inductor L11, which are distributed, e.g., configured, as illustrated in FIG. 5. The buck converter is a converter for lowering an input voltage in proportion to a switching frequency of a control signal input to the transistors T13 and T14. An operational principle of the buck converter is well known to one of ordinary skill in the art, and thus will be omitted here. The capacitor C11 stabilizes a voltage input to the buck converter.

An operational amplifier (OP AMP) A12 integrates a difference between a target voltage V12 determined by the controller 70 and a voltage value of the fuel cell 10, i.e., distributed by resistors R11 and R12 by using a capacitor C13. For example, the OP AMP A12 outputs a first value indicating an increased voltage when the voltage value of the fuel cell 10 is maintained at a value greater than the target voltage value V12 determined by the controller 70. In another example, the OP AMP A12 outputs a second value indicating a reduced voltage when the voltage value of the fuel cell 10 is maintained at a value smaller than the target voltage value V12 determined by the controller 70. In this case, the target voltage value V12 is a value for constantly maintaining the output current of the fuel cell 10 by changing the voltage value of the fuel cell 10. The controller 70 adjusts the target voltage value V12 according to a difference between the output current value of the fuel cell 10, i.e., as measured by the FC measurer 31, and a target current value.

An OP AMP A11 amplifies a difference between a reference voltage V11 and the output voltage value of the buck converter distributed by resistors R13 and R14. The reference voltage V11 is a reference voltage for adjusting a voltage range to be input to the OP AMP A11. The controller 70 switches the transistors T13 and T14 according to the output voltage of the OP AMP A11. Thus, the controller 70 may adjust the output voltage value of the buck converter according to the output current value of the fuel cell 10, so that the first DC/DC converter 41 may receive a predetermined current from the fuel cell 10.

The transistors T11 and T12 are positioned at an input terminal of the buck converter, and turn on or off a current supplied to the buck converter according to control of the controller 70. Two power MOSFETs are used to prevent reversal of current towards the fuel cell 10. The controller 70 controls switching of the transistors T11 and T12 for turning on and off the current supplied to the buck converter, and switching of the transistors T13 and T14 so as to enable or disable the first DC/DC converter 41.

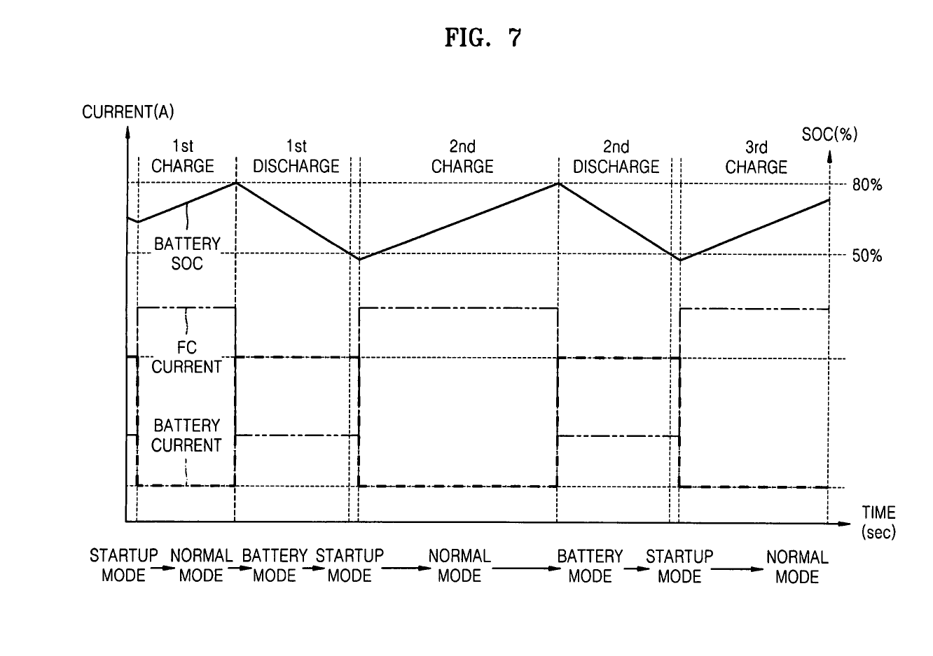

Referring further to FIG. 5, the second DC/DC converter 42 is embodied as a boost converter including transistors T22 and T23, a capacitor C22, and an inductor L21, which are distributed as illustrated in FIG. 7. The boost converter is a converter for increasing an input voltage in proportion to a switching frequency of a control signal input to the transistors T22 and T23. An operational principle of the boost converter is well known to one of ordinary skill in the art, and thus will be omitted. The capacitor C21 stabilizes a voltage input to the boost converter.

An OP AMP A21 amplifies a difference between an output voltage of the boost converter, i.e., distributed by resistors R21 and R22, and a reference voltage V22. The reference voltage V22 is a reference voltage for adjusting a voltage range to be input to the OP AMP A21. The controller 70 switches the transistors T22 and T23 according to an output voltage of the OP AMP A21. Likewise, the controller 70 may control an operation of the second DC/DC converter 42 based on an output voltage of the boost converter, so that the second DC/DC converter 42 may output a predetermined target voltage, e.g., a voltage required by the load 80.

A transistor T21 is positioned at an input terminal of the boost converter so as to turn on and off a current supplied to the boost converter according to control of the controller 70. The controller 70 controls switching of the transistor T21 for turning on and off the current supplied to the boost converter, and switching of the transistors T22 and T23 of the boost converter so as to enable or disable the second DC/DC converter 42. When the second DC/DC converter 42 is disabled, transistors T31 and T32 corresponding to the BP switch 51 are turned on, so the first DC/DC converter 41, an output terminal of the battery 20, and the load 80 are directly connected to each other. Two power MOSFETs are used to prevent reversal of current towards the battery 20.

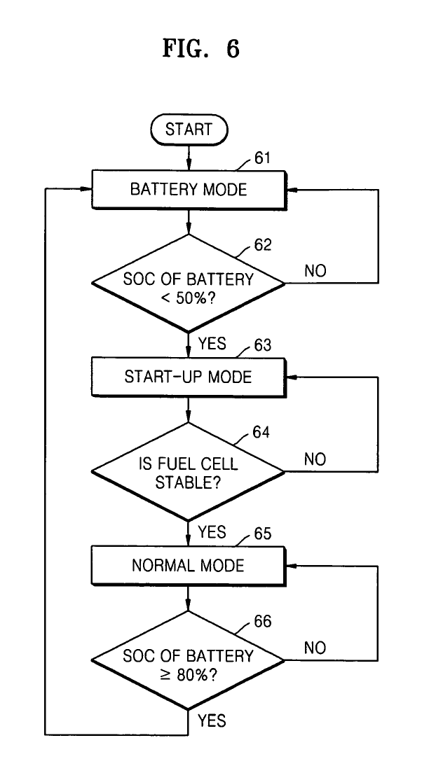

FIG. 6 is a flowchart of a power managing method of a fuel cell system according to an embodiment. Referring to FIG. 6, the power managing method according to the present embodiment includes operations that are performed in a time sequence in the controller 70 of FIG. 4. Thus, although omitted hereinafter, the details regarding the fuel cell system of FIG. 4 may also be applied to the power managing method of FIG. 6. In particular, FIG. 6 shows an operation of the controller 70 for appropriately distributing power of the fuel cell 10 and power of the battery 20 according to the SOC of the battery 20.

In Operation 61, the controller 70 controls power supplying operations of the fuel cell 10 and the battery 20 to the load 80, and an operation of the BOP 61, in a battery mode for supplying only the output power of the battery 20 to the load 80 from among various operation modes of the fuel cell system. In other words, the controller 70 sets the fuel cell system in a battery mode, i.e., the controller 70 disables the first DC/DC converter 41 in order to supply only the output power of the battery 20 to the load 80, and controls the BOP driver 62 not to drive the BOP 61. The battery mode is selected when it is assumed that the battery 20 is sufficiently charged at a beginning of an operation of the fuel cell system. Thus, other operating modes may be selected according to a charging state of the battery 20 when the operation of the fuel cell system is started.

In Operation 62, the controller 70 determines if a start-up mode for starting the operation of the fuel cell 10 is to be selected from among the various operating modes of the fuel cell system. That is, the controller 70 determines if the SOC of the battery 20 is less than a predetermined low limit, e.g., if the SOC of the battery 20 is less than about 50% of full charge, according to the discharging of the battery 20. When the SOC of the battery 20 is less than predetermined low limit, the start-up mode is selected and Operation 63 is performed. When the start-up mode is not selected, the method returns to Operation 61.

In Operation 63, the controller 70 changes the operating mode of the fuel cell system from the battery mode to the start-up mode. In the start-up mode, the controller 70 controls power supplying operations of the fuel cell 10 and the battery 20 to the load 80, and an operation of the BOP 61. That is, the controller 70 disables the first DC/DC converter 41 in order to start the operation of the fuel cell 10, and controls the BOP driver 62 to drive the BOP 61, in the start-up mode. The BOP driver 62 starts driving pumps for providing fuel, air, coolant, or the like to the fuel cell 10 according to control of the controller 70.

In operation 64, the controller 70 determines if a normal mode for starting the fuel cell 10 is to be selected, i.e., simultaneous power supply of both the fuel cell 10 and the battery 20 to the load 80, from among the various operating modes of the fuel cell system. That is, the controller 70 determines when the fuel cell 10 reaches a stable state in which the fuel cell 10 is able to supply power required by the load 80 to the load 80, based on the current value and voltage value of the fuel cell 10, as measured by the FC measurer 31. When the normal mode is selected, Operation 65 is performed. When the normal mode is not selected, the method returns to Operation 63. Since the fuel cell 10 produces power by an electrochemical reaction, it takes a relatively long time to generate power required by the load 80 from the fuel cell 10.

In operation 65, the controller 70 changes the operating mode of the fuel cell system from the start-up mode to the normal mode. In the normal mode, the controller 70 controls power supplying operations of the fuel cell 10 and the battery 20 to the load 80, and an operation of the BOP 61. That is, in the normal mode, the controller 70 enables the first DC/DC converter 41 in order to simultaneously supply power of both the fuel cell 10 and the battery 20 to the load 80, and controls the BOP driver 62 to drive the BOP 61. The output power of the first DC/DC converter 41 may be supplied to both the load 80 and the battery 20, or only to the load 80, according to a voltage difference between the output voltage of the first DC/DC converter 41 and the output voltage of the battery 20. The power output from the first DC/DC converter 41 and input to the battery 20 is used to charge the battery 20. When the output voltage of the battery 20 is reduced as the battery 20 is discharged, and power consumption of the load 80 is reduced due to a change in the load 80, the output voltage of the first DC/DC converter 41 is higher than the output voltage of the battery 20. In this case, the output current of the first DC/DC converter 41 flows into the battery 20, and thus the battery 20 is charged. Power used to charge the battery 20 is surplus power that remains after output power of the fuel cell 10 is provided to the load 80.

In Operation 66, when the SOC of the battery 20 is more than a predetermined high limit, e.g., about 80% of full charge, according to a charging state of the battery 20 in the normal mode in Operation 65, the controller 70 selects the battery mode for supplying only the output power of the battery 20, from among the various operating modes of the fuel cell system. When the battery mode is selected, the method returns to Operation 61. When the battery mode is not selected, the method returns to Operation 65.

FIG. 7 shows waveforms of the output current of the fuel cell 10 and the output current of the battery 20 in the power managing method of FIG. 6 according to an embodiment. Referring to FIG. 7, in the normal mode, as the fuel cell 10 outputs a current, a charging state of the battery 20 reaches 80%. In addition, in the battery mode and the start-up mode, as the battery 20 outputs a current, a discharging state of the battery reaches 50%. The waveforms of FIG. 7 are ideal. Actual waveforms of the output current of the fuel cell 10 and the output current of the battery 20 may be shown as curved lines, and may include ripples. Thus, by the hybrid structure in which the power of the fuel cell 10 and the power of the battery 20 may be appropriately distributed according to a change in the SOC of the battery 20, a driving time of the fuel cell 10 may be reduced, thereby realizing a fuel cell system with high fuel efficiency.

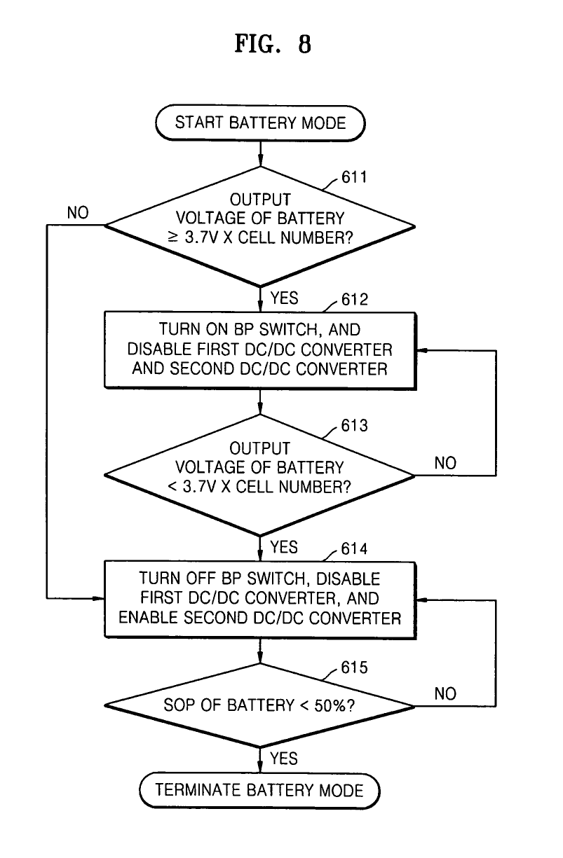

FIG. 8 is a detailed flowchart of the battery mode of Operation 61 of FIG. 6. Referring to 8, Operation 61 of FIG. 6 includes the following operations.

In Operation 611, when the output voltage of the battery 20 is equal to or greater than a predetermined target voltage, e.g., 3.7 V multiplied by a cell number of the battery 20 according to a charging state of the battery 20, or a change in the load 80, the controller 70 may proceed to Operation 612. If not, the controller 70 may proceed to Operation 614. The number of cells of the battery 20 of FIG. 5 is four. In this case, when the output voltage of the battery 20 is equal to or greater than 14.8 V, the method proceeds to Operation 612. If not, the method proceeds to Operation 614. In this case, it is assumed that a minimum voltage required by the load 80 is 14.8 V. A nominal voltage of a single cell of a lithium battery is 3.7 V. A portable electronic device corresponding to the load 80 is designed in consideration of such a nominal voltage. It is assumed that the load 80 of FIG. 4 is designed based on four cells of the lithium battery.

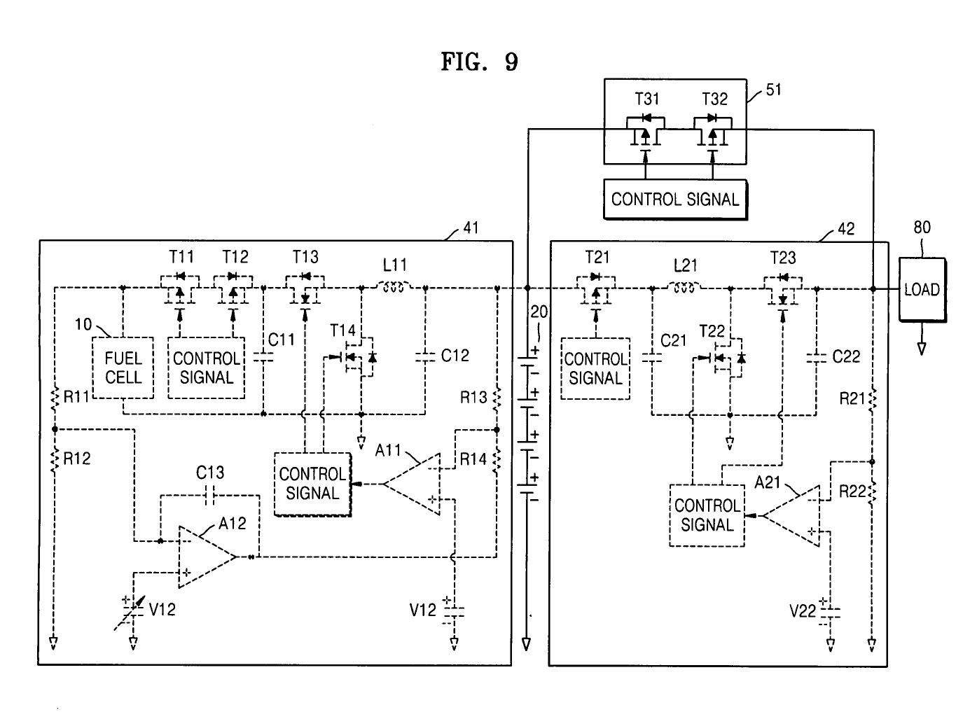

In Operation 612, the controller 70 turns off the output power supplied from the fuel cell 10, and supplies only the output power of the battery 20 by turning on the BP switch 51 and disabling the first DC/DC converter 41 and the second DC/DC converter 42. FIG. 9 shows a current flow in the battery mode when the output voltage of the battery 20 is equal to or greater than 3.7 V in the circuit diagram of FIG. 5. A dotted line indicates that a current does not flow, and a solid line indicates that a current flows. Referring to FIG. 9, the BP switch 51 is turned-on, and the second DC/DC converter 42 is disabled so that the output current of the battery 20 may be transmitted directly to the load 80 rather than being transmitted through the second DC/DC converter 42.

In Operation 613, when the output voltage of the battery 20 is less than 3.7 V according to a discharging state of the battery 20, or a change in the load 80, the controller 70 may proceed to Operation 614. When the output voltage is maintained at 3.7 V or more, the controller 70 returns to Operation 612.

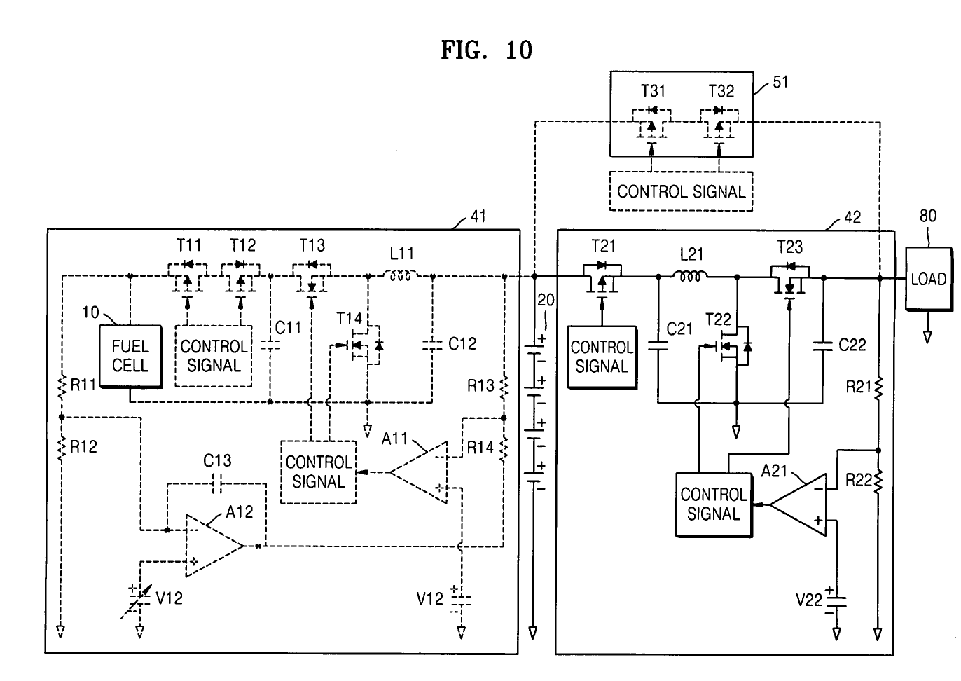

In Operation 614, the controller 70 increases the output voltage of the battery 20 to a predetermined target voltage, e.g., a voltage required by the load 80, and supplies only power of the increased output voltage by turning off the BP switch 51, disabling the first DC/DC converter 41, and enabling the second DC/DC converter 42. FIG. 10 shows a current flow in the battery mode when the output voltage of the battery 20 is less than 3.7 V. A dotted line indicates that a current does not flow, and a solid line indicates that a current flows. Referring to FIG. 10, the BP switch 51 is turned-off, and the second DC/DC converter 42 is enabled so that the output current of the battery 20 may be input to the second DC/DC converter 42, and power of voltage increased by the second DC/DC converter 42 may be transmitted to the load 80.

In Operation 615, the controller 70 terminates the battery mode, and changes the operating mode of the fuel cell system from the battery mode to the start-up mode when the SOC of the battery 20 is less than 50%.

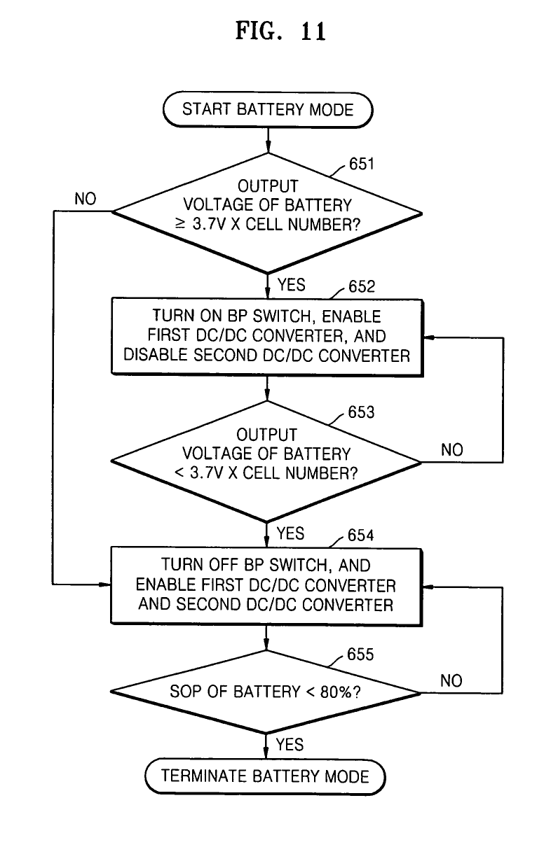

FIG. 11 is a detailed flowchart of the normal mode of Operation 65 of FIG. 6. Referring to FIG. 10, Operation 65 of FIG. 6 includes the following operations.

In Operation 651, when the output voltage of the battery 20 is equal to or greater than 3.7 V multiplied by a cell number of the battery 20 according to a charging state of the battery 20, or a change in the load 80, the controller 70 proceeds to Operation 652. If not, the controller 70 proceeds to Operation 654. In FIG. 5, the number of cells of the battery 20 is four. In this case, when the output voltage of the battery 20 is equal to or greater than 14.8 V, the method proceeds to Operation 652. If not, the method proceeds to Operation 654. In this case, it is assumed that a minimum voltage required by the load 80 is 14.8 V. The controller 70 may charge the battery 20 when the output voltage of the battery 20 is less than 3.7 V multiplied by the cell number of the battery 20 by controlling the first DC/DC converter 41 so that a constant current with 3.7 V multiplied by the cell number of the battery 20 or more may be output from the first DC/DC converter 41. In order to stably charge the battery 20, the fuel cell 10 needs to have stacks for outputting 3.7 V multiplied by the cell number of the battery 20 or more in spite of a change in the load 80, and the first DC/DC converter 41 is designed as a buck converter for lowering a voltage of stacks in order to output a constant current from the fuel cell 10.

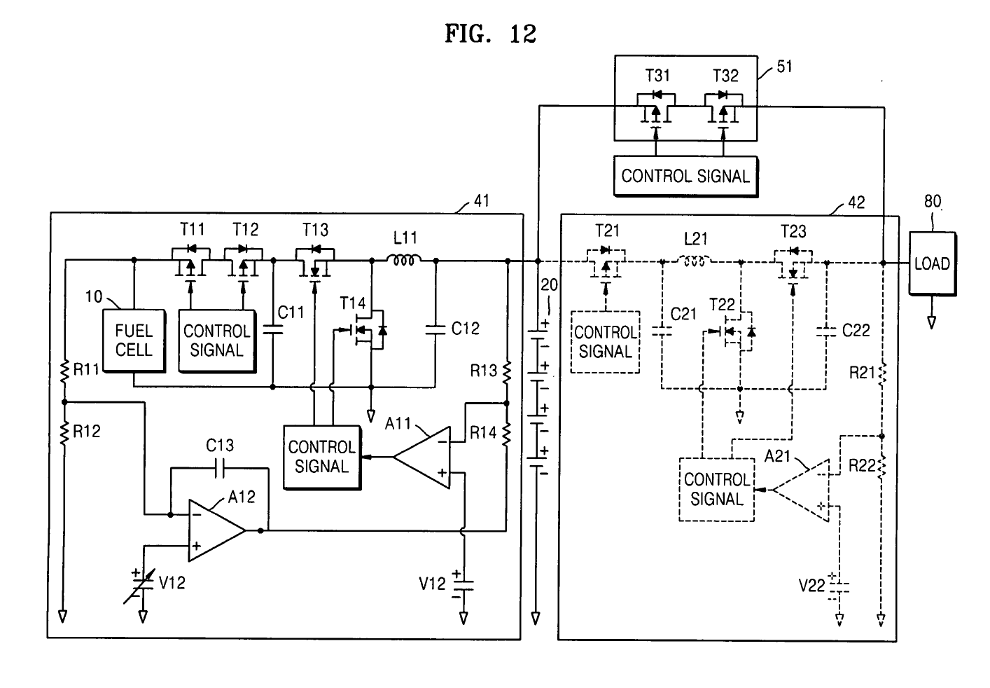

In Operation 652, the controller 70 simultaneously supplies the output power of the fuel cell 10 and the output power of the battery 20 directly to the load 80 by turning on the BP switch 51, enabling the first DC/DC converter 41, and disabling the second DC/DC converter 42. FIG. 12 shows a current flow in the normal mode when the output voltage of the battery 20 is equal to or greater than 3.7 V in the circuit diagram of FIG. 5. A dotted line indicates that a current does not flow, and a solid line indicates that a current flows. Referring to FIG. 12, the BP switch 51 is turned-on, and the second DC/DC converter 42 is disabled, so that the output current of the battery 20 may be transmitted directly to the load 80 rather than being transmitted through the second DC/DC converter 42.

In Operation 653, when the output voltage of the battery 20 is less than 3.7 V according to a discharging state of the battery 20, or a change in the load 80, the controller 70 may proceed to Operation 654. When the output voltage is maintained at 3.7 V or more, the controller 70 returns to Operation 652.

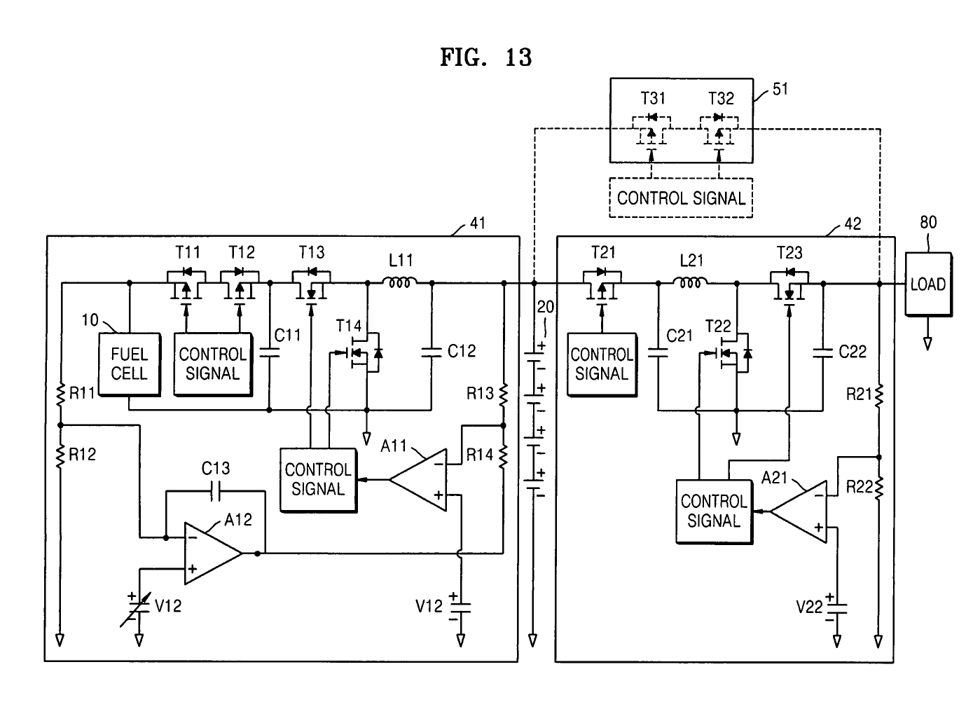

In Operation 654, the controller 70 increases the output voltage of the battery 20 to a predetermined target voltage, for example, a voltage required by the load 80, and supplies power at the increased output voltage by turning off the BP switch 51, and enabling the first DC/DC converter 41 and the second DC/DC converter 42. FIG. 13 shows a current flow in the battery mode when the output voltage of the battery 20 is less than 3.7 V in the circuit diagram of FIG. 5. A dotted line indicates that a current does not flow, and a solid line indicates that a current flows. Referring to FIG. 13, the BP switch 51 is turned-off, and the second DC/DC converter 42 is enabled so that the output current of the first DC/DC converter 41 and the output current of the battery 20 may be input to the second DC/DC converter 42, and power at a voltage increased by the second DC/DC converter 42 may be transmitted to the load 80.

In Operation 655, the controller 70 terminates the normal mode when the SOC of the battery 20 is less than 80%, and changes the operating mode of the fuel cell system from the normal mode to the battery mode.

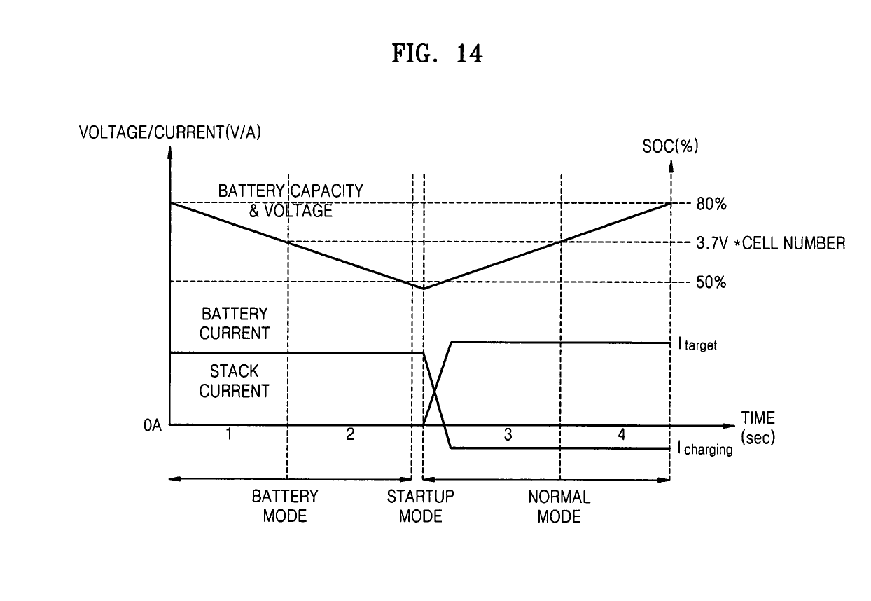

FIG. 14 shows waveforms of an output current of the fuel cell 10 and an output current of the battery 20 according to the power managing methods of FIGS. 8 and 11, according to another embodiment of the present invention. Referring to FIG. 14, in the normal mode, as the fuel cell 10 outputs a current, a charging state of the battery 20 reaches 80%. In addition, in the battery mode and the start-up mode, as the battery 20 outputs a current, a discharging state of the battery reaches 50%. In particular, in FIG. 14, when the output voltage of the battery 20 is equal to or greater than 3.7 V, the second DC/DC converter 42 is disabled. When the output voltage of the battery 20 is less than 3.7 V, the second DC/DC converter 42 is enabled. The waveforms of FIG. 14 are ideal. Actual waveforms of the output current of the fuel cell 10 and the output current of the battery 20 may be shown as curved lines, and may include ripples. Thus, since the second DC/DC converter 42 is enabled/disabled according to the output voltage of the battery 20, the input voltage of the load 80 may be stabilized, and simultaneously power consumption of the second DC/DC converter 42 may be reduced, thereby realizing a stable and highly efficient fuel cell system.

As described above, according to one or more example embodiments, a fuel cell system provides high fuel efficiency, high performance efficiency, and stabilized output voltage of the fuel cell system, while performing constant-current driving on a fuel cell.

The power managing method in the controller 70 may be written as computer programs and implemented in general-use digital computers that execute the programs using a computer readable recording medium that is tangible and non-transitory. Examples of the computer readable recording medium include magnetic storage media (e.g., ROM, floppy disks, hard disks, etc.), and storage media such as optical recording media (e.g., CD-ROMs, or DVDs).

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A fuel cell system for providing output power of at least one of a fuel cell and a battery to a load, the fuel cell system comprising:
a first converter configured to change an output voltage of the fuel cell;
a second converter configured to change an output voltage of the first converter and an output voltage of the battery; and
a controller configured to control an operation of the first converter and an operation of the second converter according to a change in performance of the battery due to battery usage.

2. The fuel cell system of claim 1, wherein the controller is configured to control operations of the first and second converters according to a change in a state of charge (SOC) of the battery and/or a change in an output voltage of the battery.

3. The fuel cell system of claim 1, wherein the controller is configured to control the operation of the first converter so that a constant current is output from the fuel cell.

4. The fuel cell system of claim 1, wherein the controller is configured to control the operation of the second converter so that power at a voltage equal to or greater than a predetermined value is supplied to the load.

5. The fuel cell system of claim 1, further comprising a switch configured to switch a direct-connection between the battery and the load, the controller controlling an operation of the first converter and an operation of the second converter according a change in the performance of the battery, and controlling on/off operations of the switch.

6. The fuel cell system of claim 5, wherein, when current performance of the battery is more than a predetermined level, the controller is configured to supply the output power of the battery to the load by disabling the first converter and turning on the switch.

7. The fuel cell system of claim 5, wherein, when current performance of the battery is less than a predetermined level, the controller is configured to supply the output power of the fuel cell and the output power of the battery to the load by enabling the first converter and turning off the switch.

8. The fuel cell system of claim 5, wherein, when the output voltage of the battery is less than a predetermined value, the controller is configured to enable the second converter, and to control the operation of the second converter so that a voltage equal to or greater than the predetermined value is output from the second converter.

9. A power managing method of a fuel cell system for providing output power of at least one of a fuel cell and a battery to a load, the power managing method comprising:
selecting an operating mode of the fuel cell system based on a change in performance of the battery due to battery usage; and
controlling supply of an output power of the fuel cell and an output power of the battery to the load according to the selected operating mode.

10. The power managing method of claim 9, wherein the change in the performance of the battery includes at least one of a change in a state of charge (SOC) of the battery and a change in an output voltage of the battery.

11. The power managing method of claim 9, wherein:
when current performance of the battery is more than a predetermined level, the selecting includes selecting a battery mode for supplying only output power of the battery to the load, and
the controlling includes turning off the output power of the fuel cell and supplying the output power of the battery to the load in the battery mode.

12. The power managing method of claim 11, wherein, when the output power of the battery is less than a predetermined value, the controlling includes increasing the output voltage of the battery and supplying power at the increased output voltage.

13. The power managing method of claim 11, further comprising:
when current performance of the battery is less than a predetermined level, changing an operating mode from the battery mode to a start-up mode; and
supplying a portion of the output power of the battery in the start-up mode, such that the operation of the fuel cell starts.

14. The power managing method of claim 13, further comprising:
when an output state of the fuel cell is stable, changing the operating mode from the start-up mode to a normal mode; and
simultaneously supplying the output power of the fuel cell and the output power of the battery to the load in the normal mode.

15. The power managing method of claim 14, wherein, when the output power of the battery is less than a predetermined value, the controlling includes increasing the output voltage of the battery and supplying power at the increased output voltage.

16. A computer readable, tangible, non-transitory recording medium having recorded thereon a program for executing a power managing method of a fuel cell system for providing output power of at least one of a fuel cell and a battery to a load, the power managing method comprising:
selecting an operating mode of the fuel cell system based on a change in performance of the battery due to battery usage; and
controlling supplying of output power of the fuel cell and output power of the battery to the load according to the selected operating mode.
